(19) United States
(12) Patent Application Publication
(10) Pub. No.: US 2014/0347726 A1
(43) Pub. Date: Nov. 27, 2014

(54) SELECTIVE HYBRID-TYPE 3D IMAGE VIEWING DEVICE AND DISPLAY METHOD USING SAME

(71) Applicant: Electronics and Telecommunications Research Institute, Daejeon (KR)

(72) Inventors: Ung-Yeon YANG, Daejeon (KR); Ki-Hong KIM, Daejeon (KR)

(73) Assignee: Electronics and Telecommunications Research Institute, Daejeon (KR)

(21) Appl. No.: 14/224,826

(22) Filed: Mar. 25, 2014

(30) Foreign Application Priority Data
May 21, 2013 (KR) 10-2013-0057081

(51) Int. Cl. G02B 27/26; G02B 27/22

(52) U.S. Cl. CPC G02B 27/26; G02B 27/2228; G02B 27/2264
USPC 359/465; 359/464

(57) ABSTRACT

A selective hybrid-type three-dimensional (3D) image viewing device and a display method using the same are disclosed. The selective hybrid-type 3D image viewing device includes a first left and right image separation module, a second left and right image separation module, and a mechanical unit. The first left and right image separation module visualizes a 3D image output from a first display so that a user can view this 3D image. The second left and right image separation module visualizes a 3D image output from a second display to which a left and right image separation technique different from that of the first display has been applied so that the user can view this 3D image. The mechanical unit is configured such that the first and second left and right image separation modules are integrated into the mechanical unit in a detachable manner.

### CROSS REFERENCE TO RELATED APPLICATION

This application claims the benefit of Korean Patent Application No. 10-2013-0057081, filed on May 21, 2013, which is hereby incorporated by reference in its entirety into this application.

### BACKGROUND OF THE INVENTION

1. Technical Field

The present invention relates generally to a three-dimensional (3D) image viewing device and, more particularly, to selective hybrid-type 3D visualization technology that incorporates a plurality of left and right image separation modules in order to universally deal with the various types of output technologies of external display devices.

2. Description of the Related Art

A process in which a human perceives 3D information is affected by various visual factors. A representative factor is the left and right eyes of a human. Binocular disparity information is generated from an image of the external world that is viewed via a human's eyes and the binocular disparity information is integrated by the brain, thereby determining a distance or a depth to an object. The principle of the perception of a 3D effect has been applied to popularized 3D display devices based on binocular disparity. A user can view 3D image content in such a manner that such a display device outputs an image to be input to the eyes of the user and the user wears a device capable of separating left and right images corresponding to the respective eyes.

Techniques for visually representing or viewing 3D image information may be classified into two types: techniques requiring a user to wear a specific device, and techniques directly outputting 3D image information onto a space without requiring a user to wear a separate device. The techniques requiring a user to wear a specific device include: an active shutter glasses technique for providing a 3D effect in such a way that left and right images of display are separately displayed on a display and the left and right images are separated by separately opening the left and left glasses; a polarized lens technique for implementing a 3D image using the polarization of light; an interference filter technique for implementing a 3D effect in such a manner that, by using interference filters, specific monochromatic light, such as red, green, and blue light, are input to the right eye and other color light is input the left eye; an anaglyph technique for implementing a 3D image using color differences; and a chromadepth technique for providing a 3D effect in such a manner that by using a prism film, an image input through a prism film is input to one eye and an actual image is input to the other eye prism film. The techniques directly outputting 3D image information onto a space without requiring a user to wear a separate device include: a holography technique for recording interference patterns on a storage medium and reproducing visible 3D images; a volumetric display technique for generating 3D flows of light by radiating light onto an actual space, so that a user can view an image from every point of view regardless of the movement of the user in a 3D manner; a lenticular technique using semi-cylindrical minute lenses; and a parallax barrier technique for alternately disposing plates for transmitting an image and plates for blocking an image and blocking an opposite side image depending on the angle of viewing of each eye, thereby providing a 3D effect.

As described above, the techniques for providing a 3D image are various. As can been seen in the case where 3D TVs were submitted as representative products in the representative world household appliance exhibitions in the early 2010s, various display devices to which various technologies have been applied have been introduced. However, 3D imaging technologies have not been fully standardized and have not been unified into a specific technology yet, and various technologies and products coexist and are used together.

Accordingly, in the case of display products each using a technique requiring the wearing of a specific device, consumers suffer from the inconvenience of wearing various wearable viewing devices corresponding to display products. In a representative example, technologies applied to wearable viewing devices that are used to watch the 3D TVs of Samsung Electronics and LG Electronics which take the lead in the current world home TV market are different and are not compatible with each other, and thus users suffer from a lot of inconvenience. This situation deteriorates users' convenience, and imposes economic burden on consumers because they should have wearable viewing devices corresponding to respective display devices. When 3D content is provided to a plurality of users or in a public place, there is the inconvenience of providing wearable viewing devices compatible with specific display products.

As a related preceding technology, U.S. Patent Application Publication No. 2012-0019638 discloses a universal 3D glasses technology that enables the various synchronization signals of active shutter-based 3D glasses to be compatible with communication technologies.

### SUMMARY OF THE INVENTION

Accordingly, the present invention has been made keeping in mind the above problems occurring in the conventional art, and an object of the present invention is to provide a universal wearable viewing device capable of dealing with various 3D image technologies and an operation method using the same.

Another object of the present invention is to provide a device that is capable of integrating and using active shutter and polarized lens technologies, which are representative technologies that take the lead in the current 3D display market.

Still another object of the present invention is to provide a method that is capable of integrating two or more left and right image separation technologies that operate in a non-obstructive manner and thus enable independent operations, respectively.

In accordance with an aspect of the present invention, there is provided a selective hybrid-type three-dimensional (3D) image viewing device, including a first left and right image separation module configured to visualize a 3D image output from a first display so that a user can view this 3D image; a second left and right image separation module configured to visualize a 3D image output from a second display to which a left and right image separation technique different from that of the first display has been applied so that the user can view this 3D image; and a mechanical unit configured such that the first and second left and right image separation modules are integrated into the mechanical unit in a detachable manner.

The first left and right image separation module may use a single left and right image separation technique that is selected from among active shutter, polarized lens, interference filter and chromadepth techniques.

The second left and right image separation module may use a single left and right image separation technique that is selected from among the active shutter, polarized lens, interference filter, and chromadepth techniques and that is not used by the first left and right image separation module.

The selective hybrid-type 3D image viewing device may further include one or more additional left and right image separation modules configured to use left and right image separation techniques different from those of the first and second left and right image separation modules, and all the left and right image separation modules included in the 3D image viewing device may operate independently.

The selective hybrid-type 3D image viewing device may further include a mechanical activation unit or an electronic control unit configured to selectively activate and stop the functions of all the left and right image separation modules.

The selective hybrid-type 3D image viewing device may further include a selective transmission processing mask/filter configured to selectively transmit and block externally input visual information or modify the information of the external image using a provided image processing filter.

The selective hybrid-type 3D image viewing device may further include a synchronization signal control unit configured to exchange synchronization control signals so that all the left and right image separation modules and the selective transmission processing mask/filter can be synchronized with an external imaging device.

The selective hybrid-type 3D image viewing device may be fabricated in the form of glasses that can be worn by the user.

In accordance with another aspect of the present invention, there is provided a display method using a selective hybrid-type 3D image viewing device, including visualizing, by left and right image separation modules, an externally input 3D image so that a user can view the 3D image; selectively transmitting and blocking, by a selective transmission processing mask/filter, externally input visual information; and exchanging, by a synchronization signal control unit, synchronization control signals with an external imaging device.

Visualizing the externally input 3D image may be performed in such a manner that two or more left and right image separation modules using different left and right image separation techniques that are selected from among active shutter, polarized lens, interference filter, and chromadepth techniques operate independently.

The left and right image separation modules may be integrated into a single mechanical unit in a detachable manner.

The 3D image viewing device may include a mechanical activation unit or an electronic control unit configured to selectively activate and stop the functions of the left and right image separation modules.

Blocking the externally input visual information may include modifying the information of the external image using an image processing filter included in the selective transmission processing mask/filter.

The 3D image viewing device may be configured in the form of glasses that can be worn by the user.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram illustrating the overall configuration of a selective hybrid-type 3D image viewing device and a display method according to embodiments of the present invention;

FIG. 2 is a diagram illustrating a selective hybrid-type 3D image viewing device according to an embodiment of the present invention;

FIG. 3 is a perspective view of a selective hybrid-type 3D image viewing device according to an embodiment of the present invention;

FIG. 4 is a diagram illustrating an implementation of a selective hybrid-type 3D image viewing device according to an embodiment of the present invention; and

FIG. 5 is a diagram illustrating the use of the selective hybrid-type 3D image viewing device according to the present invention in a space in which various display devices have been provided.

### DESCRIPTION OF THE PREFERRED EMBODIMENTS

The present invention will be described in detail below with reference to the accompanying drawings. Repeated descriptions and descriptions of known functions and configurations which have been deemed to make the gist of the present invention unnecessarily obscure will be omitted below. The embodiments of the present invention are intended to fully describe the present invention to a person having ordinary knowledge in the art to which the present invention pertains. Accordingly, the shapes, sizes, etc. of components in the drawings may be exaggerated to make the description clear.

Embodiments of the present invention will be described in detail below with reference to the accompanying drawings.

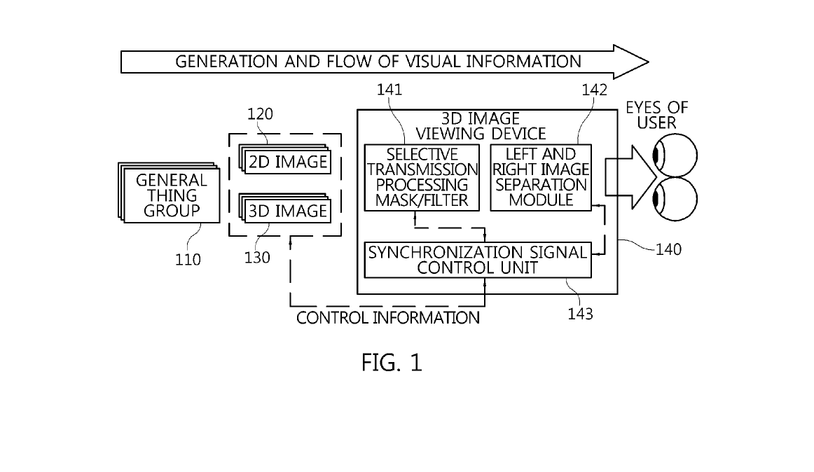

FIG. 1 is a diagram illustrating the overall configuration of a selective hybrid-type 3D image viewing device and a display method according to embodiments of the present invention.

Referring to FIG. 1, a selective hybrid-type 3D image viewing device 140 according to an embodiment of the present invention may enable the optical see-through viewing of an external general thing group 110. Alternatively, the selective hybrid-type 3D image viewing device 140 may visualize an image obtained by adding information to an external environment and the general thing group 110 using an image overlay technique supported by an augmented reality or mixed reality technology. Alternatively, the selective hybrid-type 3D image viewing device 140 may visualize a 2D image 120 and a 3D image 130 output from display devices, and may then enable a user to view them.

A selective transmission processing mask/filter 141 performs the mask function of selectively transmitting and blocking information that arrives from the outside. Alternatively, the information of an external image may be modified using various image processing filters that are used in image processing technology. To improve the image quality of a display device whose image quality has been deteriorated due to an increase in its size and the digitization thereof, high-image quality images can be supported by employing an image processing filter capable of eliminating noise applied to image signals. An external image passes through the above-described selective transmission processing mask/filter 141, or is directly input to the left and right image separation module 142 in the case where the selective transmission processing mask/filter 141 has been omitted.

The left and right image separation module 142 is a module to which a left and right image separation technique that is implemented by each of various 3D image technologies using binocular disparity information has been applied. For example, passive type linear polarized filter-based glasses that were used in the 3D theaters of Expos in the 1990s are internally provided with vertical and horizontal direction filters for left and right eyes, and the same filters are attached to a projector for outputting images corresponding to the respective eyes, thereby realizing left and right image separation. Another example left and right image separation technique is a passive type circular polarized filter-based film patterned retarder (FPR) technique that has been recently applied to the 3D TVs of LG Electronics. Furthermore, active type 3D shutter glasses that are chiefly used in the 3D TVs of Samsung Electronics separate left and right image information in such a way as to control an LCD shutter that is synchronized with an external display so that the transparency of the LCD shutter is selectively turned on and off. Other left and right image separation techniques include: an interference filter technique using a filter for distinctively transmitting image spectra; an anaglyph technique for implementing a 3D image using color differences; a chromadepth technique for generating binocular disparity in such a way, by using a prism film, image input through a prism film is input to one eye and an actual image is input to the other eye; and a Pulfrich technique for generating binocular disparity based on the difference in the transfer time of visual information the difference between the strengths of the stimuli imposed to the two eyes using a phenomenon in which when a user views an object moving in a lateral plane with a filter of a 10% to 30% transparency placed over one eye, the object is viewed as moving along an elliptical trajectory in a vertical plane.

The synchronization signal control unit 143 is provided to provide for a need to exchange synchronization control signal with an external display device in connection with the technical implementations of the selective transmission processing mask/filter 141 and the left and right image separation module 142. For a representative example, since the active shutter glasses technique is designed to exchange signals, used to synchronize the On and Off operations of left and right shutters with each other, with an external display device, synchronization control signals are exchanged with the external display device through the synchronization signal control unit 143.

A user may wear a wearable glasses-type 3D image viewing device 140 and experience images output from various display devices in a space in which the corresponding display devices have been installed.

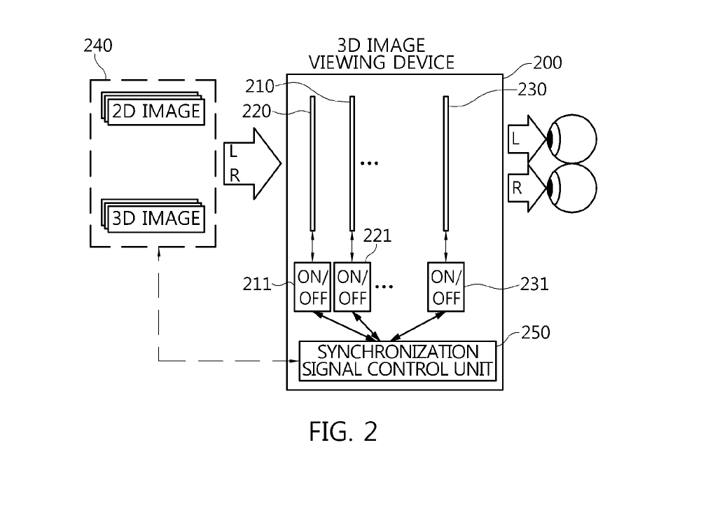

FIG. 2 is a diagram illustrating a selective hybrid-type 3D image viewing device 200 according to an embodiment of the present invention.

Referring to FIG. 2, the 3D image viewing device 200 according to this embodiment of the present invention includes two or more left and right image separation modules. The left and right image separation modules are implemented using a left and right image separation technique. Such left and right image separation techniques include the following: active shutter glasses, polarized lens, interference filter, anaglyph, chromadepth, and Pulfrich techniques, etc. The active shutter glasses technique provides a 3D effect in such a way that left and right images are separately displayed on a display and the left and right images are separated by separately opening the left and left glasses. Since the active shutter glasses technique shows different images to the eyes, respectively, a user can view an original image whose resolution or quality of color has not been degraded, and an afterimage that is generated in other techniques is weak. The polarized lens technique implements a 3D image using the polarization of light in which the waves of the light oscillate in a specific direction. In the polarized lens technique, images taken by left and right cameras are input to left and right projectors, respectively, and the images are projected onto a screen via the projectors to which different polarized filters have been attached. Thereafter, when a user views the screen via polarized glasses using the same polarization method as the polarized filters attached to the projectors, only the left image is input to the left eye and only the right image is input to the right eye, thereby achieving a 3D effect. Such polarization techniques include linear, circular and elliptical polarization techniques. The interference filter technique implements a 3D effect in such a manner that using interference filters, specific monochromatic light, such as red, green, and blue light, are input to the right eye and other color light is input the left eye. The anaglyph technique is a first-generation 3D image technology, and implements a 3D image using color differences in such a manner that a left image is generated in blue and a right image is generated in red, the two images are projected onto a screen in an overlay manner, and the left and right images are viewed via glasses to which a blue filter for the left eye and a red filter for the right eye have been attached. The chromadepth technique provides a 3D effect in such a manner that using a prism film, an image input through a prism film is input to one eye and an actual image is input to the other eye. The Pulfrich technique uses a phenomenon in which when a user views an object moving in a lateral plane with a filter of a 10% to 30% transparency placed over one eye, the object is viewed as moving along an elliptical trajectory in a vertical plane, and provides a 3D effect in such a manner that binocular disparity is generated due to the difference in the transfer time of visual information attributable to the strengths of stimuli because the strengths of the stimuli imposed to the two eyes are different.

The 3D image viewing device 200 may include two or more left and right image separation modules 210, 220 and 230. The left and right image separation modules 210, 220 and 230 operate independently, and separate the left and right image information of an external display group 240 to be suitable for the respective eyes of a user.

The left and right image separation modules 210, 220 and 230 integrated into a single mechanical unit may be manually assembled or detachably attached. Furthermore, mechanical activation units or electronic control units 211, 221 and 231 may be provided, and selectively activate and stop the functions of the left and right image separation modules 210, 220 and 230.

Furthermore, when synchronization is required between the external display group 240 and the left and right image separation modules 210, 220 and 230, synchronization control signals may be exchanged using a synchronization signal control unit 250.

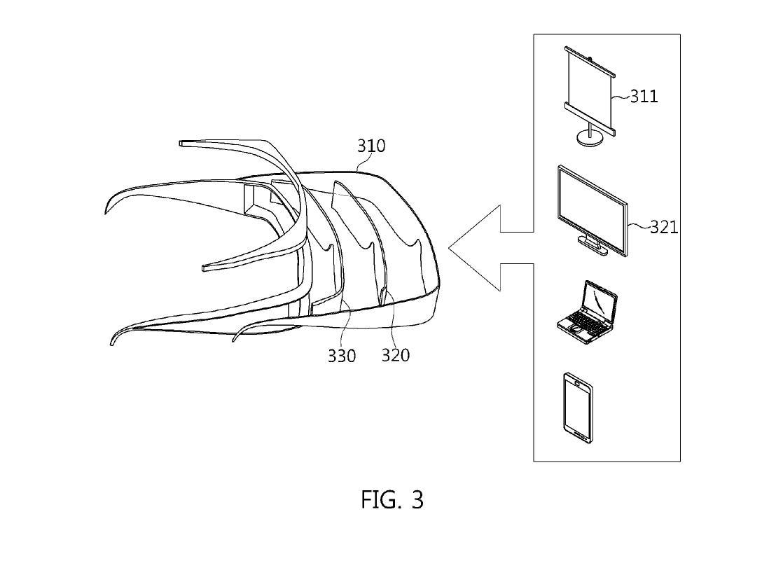

FIG. 3 is a perspective view of a selective hybrid-type 3D image viewing device according to an embodiment of the present invention.

Referring to FIG. 3, the selective hybrid-type 3D image viewing device according to this embodiment of the present invention is configured in the form of hybrid-type 3D glasses that are simultaneously compatible with various devices. Although currently, many corporations, such as Samsung electronics and LG electronics, implement 3D image technology in the screens of cinema projectors, TVs, PCs, notebooks, smart mobile devices, etc., consumers suffer from the burden of purchasing 3D glasses suitable for an imaging device whenever they purchase the device because 3D glasses suitable for each device are required. Furthermore, when various types of display devices are present in a single space, a user experiences inconvenience in the use of various types of content because his or her 3D glasses are not universally compatible.

In order to overcome the above problems, the selective hybrid-type 3D image viewing device according to the present invention integrates and implements various left and right image separation technologies, thereby enabling a user to enjoy 3D content output from various display devices using only a single viewing device. When an image output from the display 311 is viewed, the left and right image separation module 310 suitable for a left and right image separation technique that is used in the display 311 may be applied. When an image output from the display 321 is viewed, the left and right image separation module 330 suitable for the left and right image separation technique that is used in the display 321 may be applied. Furthermore, when the selective transmission processing mask/filter 320 is present, external information may be selectively transmitted and blocked, and the information of the external image may be modified using various image processing filters that are used in image processing technology.

Furthermore, since a left and right image separation module desired by a user may be manually attached and detached, the present invention provides the convenience of implementing a user customized 3D image viewing device.

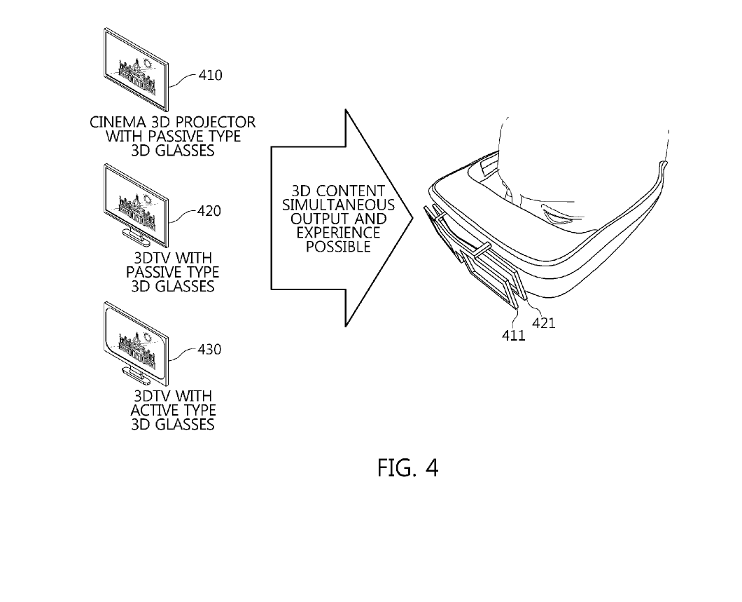

FIG. 4 is a diagram illustrating an implementation of a selective hybrid-type 3D image viewing device according to an embodiment of the present invention.

Referring to FIG. 4, the selective hybrid-type 3D image viewing device according to this embodiment of the present invention is fabricated in the form of glasses, and thus can be worn by a user. The two independent left and right image separation modules 411 and 421 are disposed in the front portion of the 3D image viewing device, and thus a user can view 3D content in an environment in which various types of 3D image display devices coexist while freely moving.

A left and right image separation module using the active shutter technique, that is, a representative left and right image separation technique, and a left and right image separation module using the polarized lens technique, that is, another representative left and right image separation technique, are attached, and thus it is possible to experience various types of 3D content regardless of the types of displays 410, 420 and 430. Meanwhile, when a left and right image separation module using the active shutter technique is attached, a power switch capable of selectively turning on and off a shutter and a synchronization signal control unit via which the displays will exchange synchronization control signals may be included.

When content is viewed via 3D displays other than the displays 410, 420 and 430 illustrated in FIG. 4, various left and right image separation modules suitable for the other 3D displays are attached to the mechanical unit and then used.

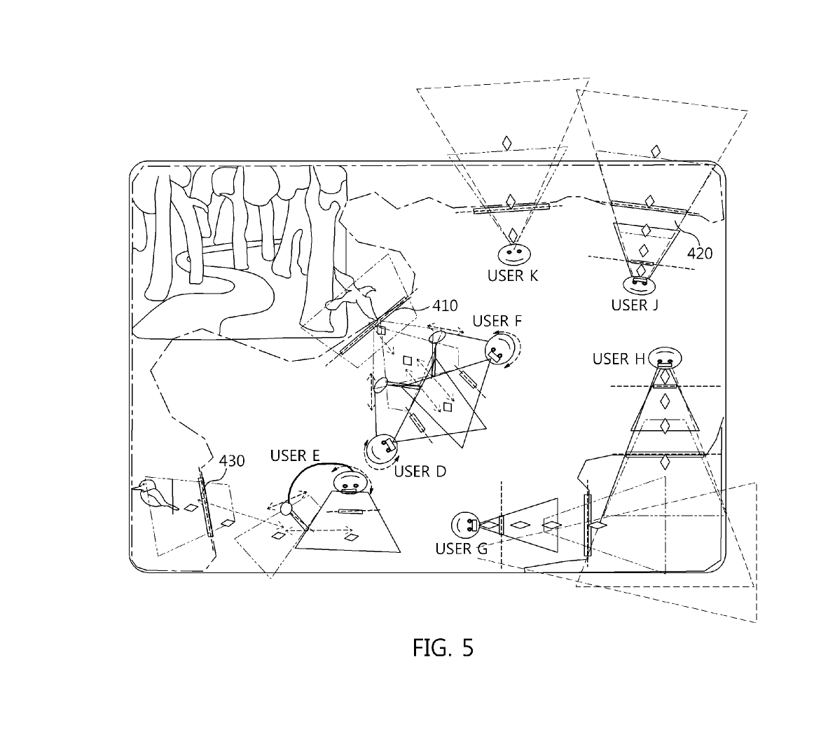

FIG. 5 is a diagram illustrating the use of the selective hybrid-type 3D image viewing device according to the present invention in a space in which various display devices have been provided.

Referring to FIG. 5, it can be seen that users D, E, F, G, H, J and K who wear selective hybrid-type 3D viewing devices according to an embodiment of the present invention experience various types of 3D content depending on various types of 3D image display devices 410, 420 and 430 in a forest experience hall in which the various types of 3D image display devices 410, 420 and 430 coexist with one another.

By means of the display 410, a situation in which a virtual bird located in a virtual forest rushes out between a plurality of users D and F, and then flies can be displayed to the plurality of users D and F, who wear the selective hybrid-type 3D viewing devices. Using this technology, the technical problem of the conventional technology in which accurate 3D content cannot be provided to a plurality of users by using a single background 3D display can be overcome.

By means of the display 420, a user J who wears the selective hybrid-type 3D viewing device can experience a virtual object that protrudes from a 3D-looking wall to a location immediately before the user J.

By means of the display 430, a situation in which a bird, that is, a virtual object, rushes out of the display 430 and moves around is displayed, and thus a user E who wears the selective hybrid-type 3D viewing device can observe a virtual moving object while moving his or her field of view.

In these cases, the users who wear the selective hybrid-type 3D viewing devices can experience all types of content without any difficulty by using the selective transmission processing mask/filters even in a virtual environment in which not only the display devices 410, 420 and 430 for outputting 3D images but also a display device for outputting 2D images and general things coexist with one another.

As described above, users can observe various types of content on various types of displays using only the selective hybrid-type 3D viewing devices even in a virtual environment in which various types of displays coexist with one another, thereby enabling the users to effectively experience a virtual environment compared to the conventional art.

The present invention has the advantage of providing the universal wearable viewing device capable of dealing with various 3D image technologies and an operation method using the same.

Furthermore, the present invention has the advantage of being capable of integrating and using active shutter and polarized lens technologies, which are representative technologies that take the lead in the current 3D display market.

Moreover, the present invention has the advantage of providing the advantage of being capable of integrating two or more left and right image separation technologies that operate in a non-obstructive manner and thus enable independent operations, respectively.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A selective hybrid-type three-dimensional (3D) image viewing device, comprising:
a first left and right image separation module configured to visualize a 3D image output from a first display so that a user can view the 3D image;
a second left and right image separation module configured to visualize a 3D image output from a second display to which a left and right image separation technique different from that of the first display has been applied so that the user can view the 3D image; and
a mechanical unit configured such that the first and second left and right image separation modules are integrated into the mechanical unit in a detachable manner.

2. The selective hybrid-type 3D image viewing device of claim 1, wherein the first left and right image separation module uses a single left and right image separation technique that is selected from among active shutter, polarized lens, interference filter and chromadepth techniques.

3. The selective hybrid-type 3D image viewing device of claim 2, wherein the second left and right image separation module uses a single left and right image separation technique that is selected from among the active shutter, polarized lens, interference filter, and chromadepth techniques and that is not used by the first left and right image separation module.

4. The selective hybrid-type 3D image viewing device of claim 1, further comprising one or more additional left and right image separation modules configured to use left and right image separation techniques different from those of the first and second left and right image separation modules, wherein all the left and right image separation modules included in the 3D image viewing device operate independently.

5. The selective hybrid-type 3D image viewing device of claim 4, further comprising a mechanical activation unit or an electronic control unit configured to selectively activate and stop functions of all the left and right image separation modules.

6. The selective hybrid-type 3D image viewing device of claim 5, further comprising a selective transmission processing mask/filter configured to selectively transmit and block externally input visual information or modify information of the external image using a provided image processing filter.

7. The selective hybrid-type 3D image viewing device of claim 6, further comprising a synchronization signal control unit configured to exchange synchronization control signals so that all the left and right image separation modules and the selective transmission processing mask/filter can be synchronized with an external imaging device.

8. The selective hybrid-type 3D image viewing device of claim 1, wherein the selective hybrid-type 3D image viewing device is fabricated in a form of glasses that can be worn by the user.

9. A display method using a selective hybrid-type 3D image viewing device, comprising:
visualizing, by left and right image separation modules, an externally input 3D image so that a user can view the 3D image;
selectively transmitting and blocking, by a selective transmission processing mask/filter, externally input visual information; and
exchanging, by a synchronization signal control unit, synchronization control signals with an external imaging device.

10. The display method of claim 9, wherein visualizing the externally input 3D image is performed in such a manner that two or more left and right image separation modules using different left and right image separation techniques that are selected from among active shutter, polarized lens, interference filter, and chromadepth techniques operate independently.

11. The display method of claim 9, wherein the left and right image separation modules are integrated into a single mechanical unit in a detachable manner.

12. The display method of claim 9, wherein the 3D image viewing device comprises a mechanical activation unit or an electronic control unit configured to selectively activate and stop functions of the left and right image separation modules.

13. The display method of claim 9, wherein blocking the externally input visual information comprises modifying information of the external image using an image processing filter included in the selective transmission processing mask/filter.

14. The display method of claim 9, wherein the 3D image viewing device is configured in a form of glasses that can be worn by the user.
